(19) United States
(12) Patent Application Publication
(10) Pub. No.: US 2026/0320573 A1
(43) Pub. Date: Oct. 15, 2026

(54) INFORMATION PROCESSING METHOD, INFORMATION PROCESSING APPARATUS, AND INFORMATION PROCESSING PROGRAM

(71) Applicant: FUJIFILM Corporation, Tokyo (JP)

(72) Inventors: Shinnosuke SONODA, Kanagawa (JP); Yutaka OISHI, Kanagawa (JP); Atsushi ITO, Kanagawa (JP); Yuko MASUDA, Kanagawa (JP); Shohei YANO, Kanagawa (JP); Yuji AKADA, Kanagawa (JP); Sae NESHIBA, Kanagawa (JP)

(73) Assignee: FUJIFILM Corporation, Tokyo (JP)

(21) Appl. No.: 19/692,233

(22) Filed: May 29, 2026

Related U.S. Application Data
(63) Continuation of application No. PCT/JP2024/039163, filed on Nov. 1, 2024.

(30) Foreign Application Priority Data
Nov. 30, 2023 (JP) 2023-203245

(51) Int. Cl. G06Q 20/10; G06Q 20/38

(52) U.S. Cl. CPC G06Q 20/10; G06Q 20/389

(57) ABSTRACT

An information processing apparatus includes a processor configured to determine an execution timing of an additional transaction to a blockchain based on a history of a transaction fee related to a transaction for evidence writing to the blockchain and a history in which the evidence writing to the blockchain has occurred.

### CROSS-REFERENCE TO RELATED APPLICATIONS

This application is a continuation application of International Application No. PCT/JP2024/039163 filed Nov. 1, 2024 the disclosure of which is incorporated herein by reference in its entirety. Further, this application claims priorities from Japanese Patent Application No. 2023-203245 filed Nov. 30, 2023, the disclosure of which is incorporated herein by reference in their entirety.

### BACKGROUND

### 1. Technical Field

The disclosed technology relates to an information processing method, an information processing apparatus, and an information processing program.

### 2. Description of the Related Art

JP2021-136031A discloses an aspect in which a historical reference value is determined based on an actual fee of an existing block transaction request in a blockchain, and in a case where the actual fee of the transaction request is equal to or greater than the historical reference value, it is determined that a result satisfies a transaction execution condition, and in a case where the actual fee of the transaction request is lower than the historical reference value, a time order in which the transaction request satisfies the transaction execution condition is determined according to a processing capacity of an initiating node.

JP2022-25720A discloses a credit device and a credit system capable of calculating a processing fee for information processing of a digital currency in a blockchain network. In particular, an aspect is disclosed in which a processing fee is calculated based on a fee charging rule, and a transaction history corresponding to a user specification information address of the digital currency is collected from the blockchain network and used as transaction information.

JP2022-542168A discloses an asset trading system that ensures transparency of a purchase history and prevents forgery and alteration in an online transaction for a high-value asset. In particular, an aspect is disclosed in which a sales condition such as the number of tokens of fractional ownership to be sold requested by a seller and an amount, and a purchase condition such as the number of tokens of fractional ownership to be purchased requested by a purchaser and an amount are matched, a transaction for the corresponding token of fractional ownership is performed in a case where the sales condition of the seller and the purchase condition of the purchaser match each other, and a transaction breakdown is added to or reflected in a ledger of the corresponding asset registered in a transaction history information DB each time the transaction is completed.

JP2021-33360A discloses an aspect in which blockchain data including a plurality of transaction histories of a cryptocurrency is acquired, chart data showing a price fluctuation of the cryptocurrency in a time series is acquired, and a part of the plurality of transaction histories included in the blockchain data and the chart data showing the price fluctuation of the cryptocurrency in a predetermined period are displayed on a screen.

JP2021-18514A discloses a technique for proving non-tampering with data collected by a company or the like, and in particular, an aspect is disclosed in which a transaction is transmitted to a blockchain, a recommended fee for immediately approving writing of the transaction to the blockchain is calculated, and a cost is calculated based on the recommended fee and the number of transactions.

### SUMMARY

Here, the usage cost (gas fee) of the public blockchain is dynamically determined according to a congestion status at a timing at which the transaction is approved or the price itself of the token of the public blockchain, and a variation range thereof is also large. Therefore, there is a problem in that it is difficult to estimate an operating cost of the entire system for a certain period in the use of the public blockchain by the company.

A method of designating a gas fee at a timing of occurrence of the transaction and waiting until the transaction is approved to stabilize a transaction fee can be adopted depending on the type of the blockchain. On the other hand, in a case where this method is adopted, there is also a problem in that, since it is not known when the transaction will be approved, in a case where writing to the blockchain does not occur for a long time, reliability related to execution of the transaction is reduced.

One aspect of the present invention is to provide an information processing method, an information processing apparatus, and an information processing program capable of determining an execution timing of a transaction in consideration of a transaction fee related to the transaction and reliability related to execution of the transaction.

According to a first aspect of the present disclosure, there is provided an information processing method comprising: determining an execution timing of an additional transaction to a blockchain based on a history of a transaction fee related to a transaction for evidence writing to the blockchain and a history in which the evidence writing to the blockchain has occurred.

According to a second aspect of the present disclosure, there is provided an information processing apparatus comprising: a processor, in which the processor is configured to determine an execution timing of an additional transaction to a blockchain based on a history of a transaction fee related to a transaction for evidence writing to the blockchain and a history in which the evidence writing to the blockchain has occurred.

According to a third aspect of the present disclosure, there is provided an information processing program causing a computer to execute a process comprising: determining an execution timing of an additional transaction to a blockchain based on a history of a transaction fee related to a transaction for evidence writing to the blockchain and a history in which the evidence writing to the blockchain has occurred.

According to one aspect, it is possible to determine the execution timing of the transaction in consideration of the transaction fee related to the transaction and the reliability related to the execution of the transaction.

### BRIEF DESCRIPTION OF THE DRAWINGS

FIG. 1 is an explanatory diagram showing a configuration example of an information processing system.

FIG. 2 is a schematic block diagram of an example of a computer functioning as a server and a user terminal according to the present embodiment.

FIG. 3 is a block diagram showing a configuration of the server according to the present embodiment.

FIG. 4 is a flowchart showing an execution timing determination processing routine in the server according to the present embodiment.

FIG. 5 is a flowchart showing transaction execution processing in the server according to the present embodiment.

### DETAILED DESCRIPTION

Hereinafter, an example of an embodiment of the disclosed technology will be described with reference to the drawings. In each drawing, the same or equivalent constituent elements and parts are designated by the same reference numerals. In addition, dimensional ratios in the drawings are exaggerated for convenience of description and may be different from the actual ratios.

In the following embodiment, “A and/or B” is synonymous with “at least one of A or B”. That is, “A and/or B” means “A, B, or a combination of A and B”. In addition, in the present specification, the same concept as in the case of “A and/or B” applies to a case where three or more matters are expressed together by “and/or”.

### <System Configuration>

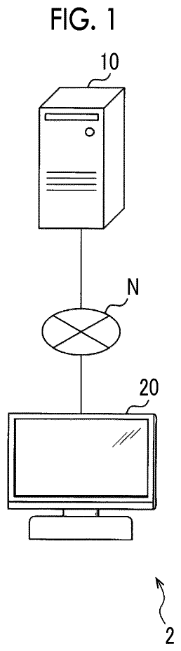

FIG. 1 is an explanatory diagram showing a configuration example of an information processing system 2. In the present embodiment, the information processing system 2 that executes a transaction for writing evidence will be described. The information processing system 2 includes a server 10 and a user terminal 20. The server 10 and the user terminal 20 are communicably connected via a network N. The server 10 is an example of an information processing apparatus.

The server 10 is, for example, a server computer capable of performing various types of information processing and transmitting and receiving information. The device corresponding to the server 10 is not limited to the server computer and may be, for example, a personal computer or the like. In the present embodiment, the server 10 functions as an information processing apparatus that determines an execution timing of a transaction for writing evidence and that executes the transaction in accordance with the determined execution timing.

The user terminal 20 is a general-purpose computer such as a personal computer. In the present embodiment, the user terminal 20 functions as a device that requests the server 10 to write evidence to the blockchain.

In the present embodiment, it is assumed that the server 10 determines the execution timing of the transaction and executes the transaction, but the local user terminal 20 may determine the execution timing of the transaction and execute the transaction. That is, the distinction between the two is for convenience, and a single computer may perform a series of processes.

### Configuration of Server According to Present Embodiment

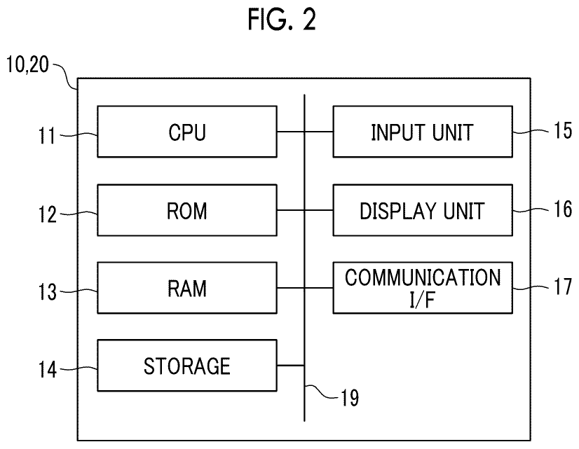

FIG. 2 is a block diagram showing a hardware configuration of the server 10 according to the present embodiment.

As shown in FIG. 2, the server 10 includes a central processing unit (CPU) 11, a read only memory (ROM) 12, a random access memory (RAM) 13, a storage 14, an input unit 15, a display unit 16, and a communication interface (I/F) 17. The components are communicably connected to each other via a bus 19.

The CPU 11 is a central processing unit, and executes various programs or controls each unit. That is, the CPU 11 reads out a program from the ROM 12 or the storage 14 and executes the program using the RAM 13 as a work area. The CPU 11 controls each configuration and performs various types of arithmetic processing in accordance with the program stored in the ROM 12 or the storage 14. In the present embodiment, the ROM 12 or the storage 14 stores an information processing program for determining an execution timing of a transaction and executing the transaction. The information processing program may be one program or a program group composed of a plurality of programs or modules.

The ROM 12 stores various programs and various kinds of data. The RAM 13 temporarily stores a program or data as a work area. The storage 14 is configured with a hard disk drive (HDD) or a solid state drive (SSD), and stores various kinds of data and various programs including an operating system.

The input unit 15 includes a pointing device such as a mouse, and a keyboard, and is used to perform various inputs.

The display unit 16 is, for example, a liquid-crystal display and displays various types of information. The display unit 16 may adopt a touch panel type to function as the input unit 15.

The communication interface 17 is an interface for communicating with other devices, and standards such as Ethernet (registered trademark), FDDI, and Wi-Fi (registered trademark) are used.

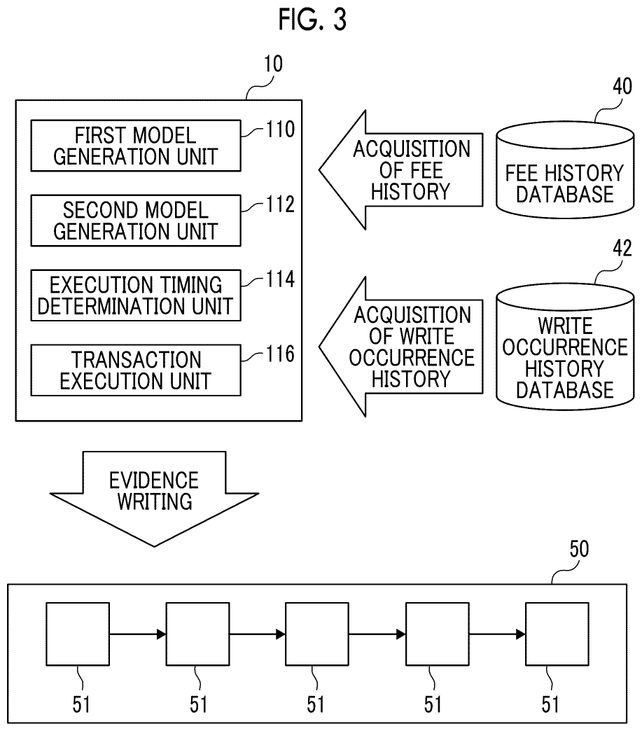

Next, a functional configuration of the server 10 will be described. FIG. 3 is a block diagram showing an example of a functional configuration of the server 10.

Functionally, as shown in FIG. 3, the server 10 is configured to include a first model generation unit 110, a second model generation unit 112, an execution timing determination unit 114, and a transaction execution unit 116.

The first model generation unit 110 creates a first stochastic process model for predicting the transaction fee based on a history of the transaction fee related to the transaction for evidence writing to the blockchain 50.

Specifically, the history of the transaction fee is acquired from a fee history database 40 in which the history of the transaction fee related to the past transaction is stored, and the first stochastic process model is created by performing regression from a set of the past transaction fee market price f and the time point t, (f₁, t_{p,1}), (f₂, t_{p,2}), . . . , (fₙ, t_{p,n}).

Here, the history of the transaction fee stored in the fee history database 40 is, for example, a graph of the published market price of the transaction fee or a record of the transaction fee paid for the past evidence writing.

In addition, the blockchain 50 is constructed by a blockchain network composed of a plurality of computer terminals, and is a blockchain in which blocks 51 including the evidence are linked in a time series. The server 10 can prevent the tampering of the evidence by writing the evidence to the block 51 on the blockchain 50 each time the evidence writing occurs.

The second model generation unit 112 creates a second stochastic process model for predicting the occurrence timing of the evidence writing request in the user terminal 20 based on a history in which the evidence writing request to the blockchain 50 has occurred in the user terminal 20.

Specifically, the second model generation unit 112 acquires a history in which the evidence writing request has occurred from a write occurrence history database 42 in which the history in which the evidence writing request to the blockchain 50 has occurred in the past in the user terminal 20 is stored. The second model generation unit 112 can create the second stochastic process model by assuming a distribution related to the occurrence time point, such as an exponential distribution, from time points t_{r,1}, t_{r,2}, . . . , t_{r,n} at which the past evidence writing requests have been made.

The history in which the evidence writing request has occurred, which is stored in the write occurrence history database 42, is, for example, a history of the time point at which the evidence writing request has occurred in the past in the user terminal 20.

The execution timing determination unit 114 determines the execution timing of the additional transaction to the blockchain 50 based on the first stochastic process model and the second stochastic process model.

Specifically, the execution timing determination unit 114 determines the execution timing of the additional transaction to optimize an objective function. The objective function is represented by using the occurrence timing of the evidence writing, which is predicted based on the second stochastic process model, and the transaction fee, which is predicted based on the first stochastic process model, at the execution timing of the additional transaction corresponding to the occurrence timing of the evidence writing.

More specifically, the objective function is represented by using the expected value of the transaction fee at the execution timing of the additional transaction, the standard deviation (dispersion) of the transaction fee at the execution timing of the additional transaction, and the waiting time from the occurrence timing of the evidence writing to the execution timing of the additional transaction.

In the optimization calculation of the objective function, (i) the standard deviation (dispersion) of the total value of the transaction fees, (ii) the expected value of the total value of the transaction fees, and (iii) the waiting time from the occurrence of the evidence writing to the actual issuance of the transaction are defined as a multi-objective optimization problem to be optimized. In this case, a solution for simultaneously optimizing all the objective functions generally does not exist, and a Pareto optimal curve is obtained. At the timing of actually executing the execution plan, one point on the curve is selected by a weighted sum using respective predetermined weights.

The standard deviation (dispersion) of the total value of the transaction fees (i) and the waiting time (iii) are in a trade-off relationship. In a case where the frequency of writing is low (once a month), the standard deviation (dispersion) of the transaction fee is small, while the waiting time is long. In a case where the frequency of writing is high, the standard deviation (dispersion) is large, and the waiting time is short.

Regarding the expected value of the total value of the transaction fees (ii), in a case where a large amount is designated as the transaction fee, writing can be performed immediately, and in that case, the waiting time is short and the standard deviation (dispersion) is small. On the contrary, in a case where a small amount is designated as the transaction fee, the waiting time is long and the standard deviation (dispersion) is large.

As an example of the waiting time (iii), in a case where the transaction comes three times (at a high frequency) in one second (short time), it is expected that writing will continue for a while. On the other hand, in a case where the transaction comes once (low frequency) in one hour (long time), it is expected that the waiting time is long.

For example, the objective function is represented by the following equation.

$$minimize {C}_{1} Var [ {\sum }_{i = 1}^{k} {F}_{{t}_{i}} ] + {C}_{2} E [ {\sum }_{i - 1}^{k} {F}_{{t}_{i}} ] + {C}_{3} {\sum }_{i = 1}^{k} {\sum }_{j = {s}_{i}}^{{s}_{i + 1} - 1} ( {t}_{i} - {τ}_{j} )$$

Here, Fₜ is the transaction fee at time point t predicted based on the first stochastic process model, tᵢ is a time point when the transaction for writing to the blockchain is executed for the i-th time, τⱼ is a time point when the user terminal 20 makes a request to write to the blockchain for the j-th time, predicted based on the second stochastic process model, and sᵢ is the oldest transaction number when the transaction for collectively writing to the blockchain for the i-th time is executed. In addition, C₁, C₂, and C₃ are weight constants used in a case where one solution is selected from the Pareto solutions. For example, C₁>C₂>C₃.

The decision variables obtained by optimizing the objective function are the time point tᵢ indicating the execution timing of the transaction for actually writing to the blockchain, and the variable k indicating the number of times the transaction for writing to the blockchain is finally executed.

By optimizing the objective function, the time point tᵢ indicating the execution timing of the transaction for actually writing to the blockchain and the variable k indicating the number of times the transaction for writing to the blockchain is finally executed are determined. In this case, the time point tᵢ and the variable k are determined such that the expected value of the transaction fee at the execution timing of the additional transaction is small, the dispersion of the transaction fee at the execution timing of the additional transaction is small, and the waiting time from the occurrence timing of the evidence writing to the execution timing of the additional transaction is short.

In the objective function optimization, for example, for each value of k (k=1, 2, 3, . . . ), the time point tᵢ indicating the execution timing of the transaction for actually writing to the blockchain, which optimizes the objective function, is obtained, the value of k at which the optimal value of the objective function is minimized is specified, and the specified value of k and the time point tᵢ at the value of k are determined as the variables for optimizing the objective function.

In the modeling, a method of an optimal control theory may be used instead of the method of the objective function optimization. In addition, in the objective function optimization, the problem may be solved as an optimization problem of equivalent decision variables, or metaheuristics such as a Monte Carlo method may be used. In addition, the weight constants C₁, C₂, and C₃ may not only be fixed values but also be adjusted manually each time, or may be implemented to be dynamically changed by an algorithm. In addition, the first stochastic process model and the second stochastic process model may be parametric models defined by operations between decision variables, or may be implemented by regression using a nonparametric model such as a regression tree.

The transaction execution unit 116 actually executes the additional transaction to the blockchain 50 in accordance with the execution timing of the additional transaction to the blockchain 50 determined by the execution timing determination unit 114.

### Configuration of User Terminal According to Present Embodiment

FIG. 2 is a block diagram showing a hardware configuration of the user terminal 20 according to the present embodiment.

As shown in FIG. 2, similarly to the server 10, the user terminal 20 includes a CPU 11, a ROM 12, a RAM 13, a storage 14, an input unit 15, a display unit 16, and a communication interface (I/F) 17. The components are communicably connected to each other via a bus 19.

A program for requesting the server 10 to write the evidence is stored in the ROM 12 or the storage 14. The program may be one program or a program group composed of a plurality of programs or modules.

The input unit 15 receives evidence to be written to the blockchain 50. For example, evidence related to medical data or inventory data is received.

In a case where the evidence to be written to the blockchain 50 is received, the CPU 11 requests the server 10 to write the evidence.

### Operation of Server 10 According to Present Embodiment

Next, the operation of the server 10 according to the present embodiment will be described.

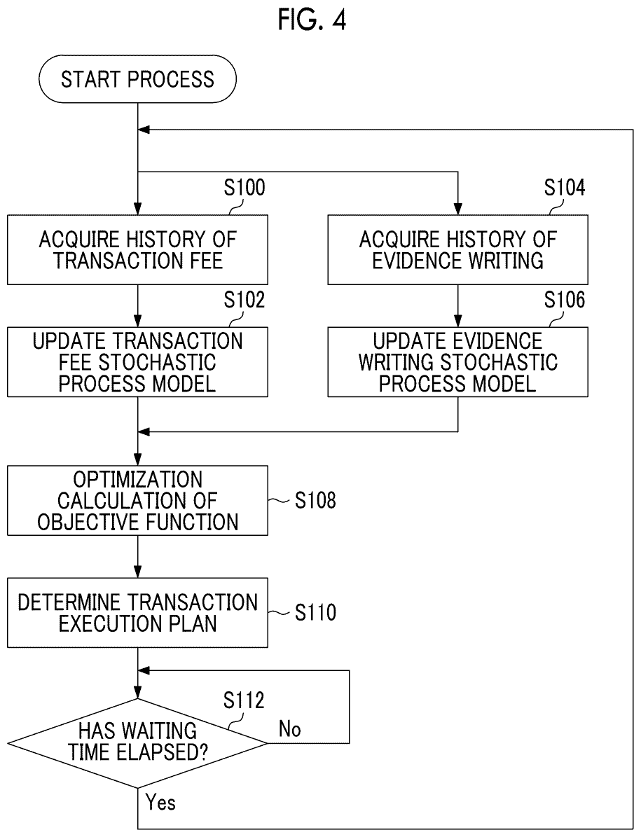

First, the CPU 11 reads out the information processing program from the ROM 12 or the storage 14, loads the information processing program into the RAM 13, and executes the information processing program, thereby performing the execution timing determination processing shown in FIG. 4. In a case where there are a plurality of user terminals 20, the execution timing determination processing is performed for each user terminal 20.

First, in step S100, the CPU 11, as the first model generation unit 110, acquires the history of the transaction fee from the fee history database 40.

In step S102, the CPU 11, as the first model generation unit 110, updates the first stochastic process model for predicting the transaction fee based on the history of the transaction fee.

In step S104, the CPU 11, as the second model generation unit 112, acquires the history in which the evidence writing request has occurred in the user terminal 20 from the write occurrence history database 42.

In step S106, the CPU 11, as the second model generation unit 112, creates the second stochastic process model for predicting the occurrence timing of the evidence writing request in the user terminal 20 based on the acquired history in which the evidence writing request has occurred.

In step S108, the CPU 11, as the execution timing determination unit 114, determines the execution timing of the additional transaction to optimize the objective function. Here, the execution timing of the additional transaction is determined for a time longer than a waiting time to be described later. The objective function is represented by using the occurrence timing of the evidence writing request, the occurrence timing being predicted based on the second stochastic process model, and the transaction fee at the execution timing of the additional transaction, the execution timing corresponding to the occurrence timing of the evidence writing request, the transaction fee being predicted based on the first stochastic process model.

In step S110, the CPU 11, as the execution timing determination unit 114, determines the execution plan of the transaction based on the execution timing of the additional transaction determined in step S108.

In step S112, the CPU 11 determines whether or not a predetermined waiting time (for example, several hours, 24 hours, or one week) has elapsed, and in a case where it is determined that the waiting time has elapsed, the process returns to steps S100 and S104.

As described above, the execution timing determination processing is realized by solving the optimization problem with the stochastic variables and the regression problem of predicting the stochastic process of the decision variables in stages.

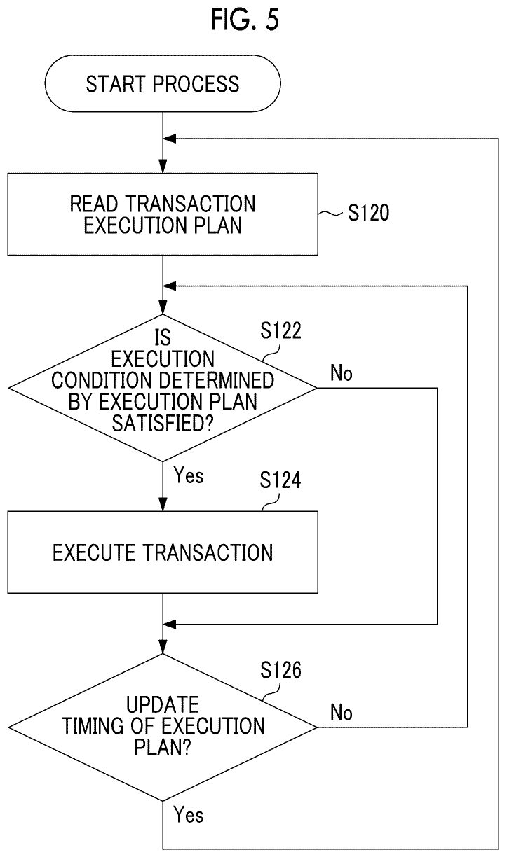

Next, the CPU 11 reads out the information processing program from the ROM 12 or the storage 14, loads the information processing program into the RAM 13, and executes the information processing program, thereby performing the transaction execution processing shown in FIG. 5. In addition, it is assumed that the evidence writing request is input to the server 10 from the user terminal 20 at any time.

First, in step S120, the CPU 11, as the transaction execution unit 116, reads the execution plan of the transaction obtained in the execution timing determination processing.

In step S122, the CPU 11, as the transaction execution unit 116, determines whether or not the execution condition determined by the execution plan is satisfied. For example, in a case where the current time is the execution timing determined in the execution plan and a new evidence writing request is received, it is determined that the execution condition is satisfied, and the process proceeds to step S124. On the other hand, in a case where the current time is not the execution timing determined in the execution plan or a new evidence writing request is not received, it is determined that the execution condition is not satisfied, and the process proceeds to step S126.

In step S124, the CPU 11, as the transaction execution unit 116, executes an additional transaction of writing the evidence in accordance with the new evidence writing request received from the user terminal 20.

In step S126, the CPU 11 determines whether or not the current time is the update timing of the execution plan. For example, in a case where a certain waiting time has elapsed, it is determined that the current time is the timing at which the execution plan is updated in the execution timing determination processing, and the process returns to step S120. On the other hand, in a case where a certain waiting time has not elapsed, it is determined that the current time is not the timing at which the execution plan is updated in the execution timing determination processing, and the process returns to step S122.

In the transaction execution processing, step S126 may be omitted. In this case, each time the transaction execution processing is repeatedly executed, the execution plan of the transaction obtained in the execution timing determination processing may be read in step S120.

As described above, with the information processing system according to the present embodiment, the execution timing of the additional transaction to the blockchain is determined based on the history of the transaction fee and the history in which the evidence writing request has occurred. As a result, the execution timing of the transaction can be determined in consideration of the transaction fee related to the transaction and the reliability related to the execution of the transaction. In addition, the execution timing of the additional transaction can be controlled while taking a balance between the transaction fee and the reliability in consideration of the trade-off between the transaction fee related to the transaction and the reliability related to the execution of the transaction.

In addition, the execution timing of the transaction for collectively writing to the blockchain is included as a variable to be optimized in the objective function, and the transaction is executed in accordance with the solution obtained as a result of the optimization calculation. As a result, the payment amount of the transaction fee can be stabilized.

### MODIFICATION EXAMPLE

The present invention is not limited to the above-described embodiments, and various modifications and applications can be made without departing from the gist of the present invention.

For example, in the above-described embodiment, a case where the transaction execution plan is obtained in advance from the past history and the transaction is executed with reference to the transaction execution plan in a case where the evidence writing request occurs has been described as an example, but the present invention is not limited thereto. For example, the transaction execution plan may be obtained by the optimization calculation of the objective function, including not only the past history but also the transaction currently waiting.

In addition, in a case where a long-term trend of fluctuation in the transaction fee is expected, upon performing the optimization of the objective function in a long time span, there is a possibility that the variables to be optimized increase and it is difficult to obtain the optimal solution. In such a case, first, the optimization of the objective function corresponding to the long-term trend may be performed to determine the variables to be optimized, and then multi-stage optimization in which the optimization of the objective function in a relatively short period is sequentially repeated may be performed.

Various processors other than the CPU may execute various types of processing executed by the CPU by reading software (program) in each of the above-described embodiments. In this case, examples of the processors include a programmable logic device (PLD) of which a circuit configuration can be changed after manufacturing, such as a field-programmable gate array (FPGA), and a dedicated electric circuit that is a processor having a circuit configuration dedicatedly designed to execute specific processing, such as an application specific integrated circuit (ASIC). In addition, the execution timing determination processing and the transaction execution processing may be executed by one of the various processors, or may be executed by a combination of two or more processors of the same type or different types (for example, a plurality of FPGAs, a combination of a CPU and an FPGA, or the like). Furthermore, the hardware structures of the various processors are more specifically electrical circuitry where circuit elements, such as semiconductor elements, are combined.

Additionally, in each of the above-described embodiments, an aspect has been described in which the information processing program is stored (installed) in advance in the storage 14, but the present disclosure is not limited to this aspect. The program may be provided in a form stored in a non-transitory storage medium such as a compact disk read only memory (CD-ROM), a digital versatile disk read only memory (DVD-ROM), and a universal serial bus (USB) memory. Alternatively, a form in which the program is downloaded from an external apparatus through a network may be available.

The embodiments disclosed herein should be considered to be merely examples and not restrictive in all respects. The scope of the present invention is indicated not by the foregoing description, but by the claims, and is intended to include all modifications within the meaning and scope equivalent to the claims.

The following supplementary notes are further disclosed with respect to the above embodiment.

### (Supplementary Note 1)

An information processing method comprising:
determining an execution timing of an additional transaction to a blockchain based on a history of a transaction fee related to a transaction for evidence writing to the blockchain and a history in which the evidence writing to the blockchain has occurred.

### (Supplementary Note 2)

The information processing method according to Supplementary Note 1,
in which the execution timing of the additional transaction is determined based on a stochastic process model of a transaction fee obtained from the history of the transaction fee and/or a stochastic process model of an evidence writing timing obtained from the history of the evidence writing.

### (Supplementary Note 3)

The information processing method according to Supplementary Note 2,
in which the execution timing of the additional transaction is determined to optimize an objective function represented by using an occurrence timing of the evidence writing, the occurrence timing being estimated based on the stochastic process model of the evidence writing timing, and a transaction fee at the execution timing of the additional transaction, the execution timing corresponding to the occurrence timing of the evidence writing, the transaction fee being estimated based on the stochastic process model of the transaction fee.

### (Supplementary Note 4)

The information processing method according to Supplementary Note 3,
in which the objective function is represented by using
   an expected value of the estimated transaction fee at the execution timing of the additional transaction,
   a standard deviation of the estimated transaction fee at the execution timing of the additional transaction, and
   a waiting time from the occurrence timing of the evidence writing to the estimated execution timing of the additional transaction.

### (Supplementary Note 5)

An information processing apparatus comprising:
a processor,
in which the processor is configured to determine an execution timing of an additional transaction to a blockchain based on a history of a transaction fee related to a transaction for evidence writing to the blockchain and a history in which the evidence writing to the blockchain has occurred.

### (Supplementary Note 6)

An information processing program causing a computer to execute a process comprising:
determining an execution timing of an additional transaction to a blockchain based on a history of a transaction fee related to a transaction for evidence writing to the blockchain and a history in which the evidence writing to the blockchain has occurred.

The disclosure of JP2023-203245 is incorporated in the present specification by reference in its entirety.

All documents, patent applications, and technical standards disclosed in the present specification are incorporated in the present specification by reference to the same extent as in a case where each of the documents, patent applications, and technical standards is specifically and individually indicated to be incorporated by reference.

What is claimed is:

1. An information processing method comprising:
determining an execution timing of an additional transaction to a blockchain based on a history of a transaction fee related to a transaction for evidence writing to the blockchain and a history in which the evidence writing to the blockchain has occurred.

2. The information processing method according to claim 1,
wherein the execution timing of the additional transaction is determined based on a stochastic process model of a transaction fee obtained from the history of the transaction fee and/or a stochastic process model of an evidence writing timing obtained from the history of the evidence writing.

3. The information processing method according to claim 2,
wherein the execution timing of the additional transaction is determined to optimize an objective function represented by using an occurrence timing of the evidence writing, the occurrence timing being estimated based on the stochastic process model of the evidence writing timing, and a transaction fee at the execution timing of the additional transaction, the execution timing corresponding to the occurrence timing of the evidence writing, the transaction fee being estimated based on the stochastic process model of the transaction fee.

4. The information processing method according to claim 3,
wherein the objective function is represented by using
an expected value of the estimated transaction fee at the execution timing of the additional transaction,
a standard deviation of the estimated transaction fee at the execution timing of the additional transaction, and
a waiting time from the occurrence timing of the evidence writing to the estimated execution timing of the additional transaction.

5. An information processing apparatus comprising:
a processor,
the processor being configured to determine an execution timing of an additional transaction to a blockchain based on a history of a transaction fee related to a transaction for evidence writing to the blockchain and a history in which the evidence writing to the blockchain has occurred.

6. A non-transitory storage medium storing a program executable by a computer so as to execute information processing, the information processing including:
determining an execution timing of an additional transaction to a blockchain based on a history of a transaction fee related to a transaction for evidence writing to the blockchain and a history in which the evidence writing to the blockchain has occurred.
